(19) United States
(12) Patent Application Publication
(10) Pub. No.: US 2025/0027521 A1
(43) Pub. Date: Jan. 23, 2025

(54) Tolerance Compensation Assembly

(71) Applicant: Illinois Tool Works Inc., Glenview, IL (US)

(72) Inventor: Weibin LIU, Shanghai (CN)

(21) Appl. No.: 18/767,553

(22) Filed: Jul. 9, 2024

(30) Foreign Application Priority Data
Jul. 18, 2023 (CN) 202310883513.0

(51) Int. Cl. F16B 5/02; F16B 37/00

(52) U.S. Cl. CPC F16B 5/0283; F16B 37/00

(57) ABSTRACT

The present disclosure provides a tolerance compensation assembly, comprising a nut assembly (102, 103) and a holder (101), wherein the nut assembly comprises a mounting nut (301) and an adjusting nut (302), the adjusting nut (302) being configured to be at least partially received in the mounting nut (301), and the adjusting nut (302) being rotatable relative to the mounting nut (301) by means of thread fit so as to move relative to the mounting nut (301) along an axial direction of the nut assembly; and wherein the holder (101) has a mounting channel (211) and a holder connecting portion (215), the holder connecting portion (215) being configured to fit with a nut connecting portion (425) such that the mounting nut (301) is capable of being held in the mounting channel (211), and the holder connecting portion (215) and the nut connecting portion (425) being at least partially disposed within the mounting channel (211). The tolerance compensation assembly according to the present disclosure has a small size in the axial direction.

### RELATED APPLICATION

The present application claims the benefit of Chinese Patent Application No. 202310883513.0, filed Jul. 18, 2023, titled “Tolerance Compensation Assembly,” the contents of which are hereby incorporated by reference.

### BACKGROUND

The present disclosure relates to a tolerance compensation assembly having an adjustable axial length. In various industrial applications, such as the automobile industry, components are connected together by using a fastener. In some applications, there may be a gap between the components. For example, two panels are spaced apart by a gap, and the two panels need to maintain the gap between them while being fastened by the fastener so as to prevent the

### SUMMARY

The present disclosure relates generally to an operating mechanism for operating vehicle doors, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a tolerance compensation assembly according to the present disclosure.

FIG. 1B is an exploded view of the tolerance compensation assembly in FIG. 1A.

FIG. 2A is a perspective view of a holder in FIG. 1B.

FIG. 2B is a perspective view of the holder in FIG. 2A from a second perspective.

FIG. 2C is a perspective view of the holder in FIG. 2A from a third perspective.

FIG. 2D is a perspective view of the holder in FIG. 2A.

FIG. 3A is a perspective view of a nut assembly in FIG. 1B.

FIG. 3B is an exploded view of the nut assembly in FIG. 1B.

FIG. 4A is a perspective view of a mounting nut in FIG. 3B.

FIG. 4B is a perspective view of the mounting nut in FIG. 4A from another perspective.

FIG. 4C is a bottom view of the mounting nut in FIG. 4A.

FIG. 5 is a perspective view of an adjusting nut in FIG. 3B.

FIG. 6A is a perspective view of the mounting nut in FIG. 3B and the holder in FIG. 1B.

FIG. 6B is a perspective view of the mounting nut in FIG. 3B and the holder in FIG. 1B from another perspective.

FIG. 7 is a perspective view of one nut assembly and the holder in FIG. 1B.

FIG. 8 is a perspective view of the tolerance compensation assembly in FIG. 1A, a first component, a second component, and fastening bolts.

FIG. 9A is a side view of the tolerance compensation assembly connected with the second component.

FIG. 9B is a side view of the tolerance compensation assembly adjusted to an appropriate length.

FIG. 9C is a schematic view of the first component and the second component connected to each other in a fastening manner.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein.

Various specific aspects of the present disclosure will be described below with reference to the accompanying drawings which constitute part of the present disclosure. It should be understood that although the terms indicating orientations, such as “front”, “rear”, “upper”, “lower”, “left” and “right”, are used in the present disclosure to describe various exemplary structural parts and elements of the present disclosure, these terms used herein are only for ease of description and are determined based on the exemplary orientations shown in the accompanying drawings. Since the aspects disclosed in the present disclosure can be arranged in different directions, these terms indicating directions are only illustrative and should not be considered as limitations. Where possible, the same or similar reference signs used in the present disclosure refer to the same elements.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a tolerance compensation assembly, including a nut assembly and a holder, wherein the nut assembly includes a mounting nut and an adjusting nut; the mounting nut including a mounting nut barrel portion and a nut connecting portion connected to the mounting nut barrel portion, the mounting nut barrel portion having an internal thread, and the adjusting nut having an external thread, being configured to be at least partially received in the mounting nut barrel portion, and being rotatable relative to the mounting nut by means of thread fit so as to move relative to the mounting nut along an axial direction of the nut assembly; and the holder has a mounting channel and a holder connecting portion, the holder connecting portion being configured to fit with the nut connecting portion such that the mounting nut is capable of being held in the mounting channel, and the holder connecting portion and the nut connecting portion being at least partially disposed within the mounting channel.

In the tolerance compensation assembly as described above, the holder includes a flat plate-shaped mounting portion, the mounting portion having a first side and a second side disposed opposite each other, the mounting channel running through the first side and the second side, and the holder connecting portion and the nut connecting portion being disposed within the mounting channel.

In the tolerance compensation assembly as described above, the mounting nut further includes a mounting nut flange portion extending outwards from one end of the mounting nut barrel portion along a radial direction of the nut assembly, the nut connecting portion being connected to the mounting nut flange portion and extending towards the other end of the mounting nut barrel portion along the axial direction of the nut assembly.

In the tolerance compensation assembly as described above, the nut connecting portion includes at least one leg having a proximal end connected to one side of the mounting nut; and the holder connecting portion includes at least one receiving portion having a proximal end connected to an inside wall of the mounting channel, the at least one receiving portion being elastic, and a distal end of the at least one leg being connected to a distal end of the at least one receiving portion by means of a snap-fit structure.

In the tolerance compensation assembly as described above, the distal end of the at least one leg has a protrusion, the at least one receiving portion includes a pair of holding arms, and distal ends of the pair of holding arms are movable away from each other such that the protrusion of the at least one leg is capable of being inserted between the pair of holding arms.

In the tolerance compensation assembly as described above, the nut connecting portion further includes at least one hook portion, a distal end of the hook portion having a claw portion extending along a radial direction of the nut assembly; and the holder connecting portion includes at least one platform portion, the claw portion being capable of cooperating with the platform portion to limit the movement of the claw portion relative to the platform portion along the axial direction of the nut assembly; wherein the at least one hook portion is spaced apart from the at least one leg.

In the tolerance compensation assembly as described above, the mounting nut flange portion is in an anti-rotation shape, the first side of the holder has a recess, the shape of the recess fitting with the shape of the mounting nut flange portion, and the mounting nut flange portion being capable of entering the recess to limit the rotation of the mounting nut relative to the holder.

In the tolerance compensation assembly as described above, the adjusting nut includes an adjusting nut flange portion and an adjusting nut barrel portion extending outwards from one end of the adjusting nut barrel portion along the radial direction of the nut assembly, the external thread being disposed on an outer surface of the adjusting nut barrel portion, the adjusting nut barrel portion being capable of entering the mounting nut barrel portion, and the adjusting nut flange portion having at least one notch; and the holder has at least one limiting portion configured to be capable of entering the at least one notch to limit the rotation of the adjusting nut relative to the mounting nut.

In the tolerance compensation assembly as described above, the holder includes at least one elastic arm, the elastic arm having a proximal end connected to an inner side of the mounting channel and having a distal end that is a free end, and the at least one limiting portion being connected to the distal end of the elastic arm and extending along the axial direction of the nut assembly; wherein the elastic arm extends around the mounting nut barrel portion.

In the tolerance compensation assembly as described above, the at least one notch includes a plurality of notches uniformly distributed in a circumferential direction, the at least one limiting portion includes a plurality of limiting portions, at least one of the plurality of limiting portions being capable of entering the corresponding one notch of the plurality of notches.

In the tolerance compensation assembly as described above, the holder includes at least two mounting channels and a fixing portion, the at least two mounting channels allowing the mounting of at least two nut assemblies, and the fixing portion being connectable to a mounting part.

In the tolerance compensation assembly as described above, the nut assembly further includes a hollow sleeve disposed in the adjusting nut barrel portion.

In the present disclosure, the tolerance compensation assembly includes the nut assembly and the holder. The holder is provided with the mounting channel in which the nut assembly is disposed. The structures connecting the nut assembly to the holder are disposed inside the mounting channel, such that the tolerance compensation assembly has a small size in the axial direction of the nut assembly and is suitable for use in a narrow mounting space. According to the present disclosure, the holder further has the limiting portion, which can prevent the nut assembly from loosening during transportation.

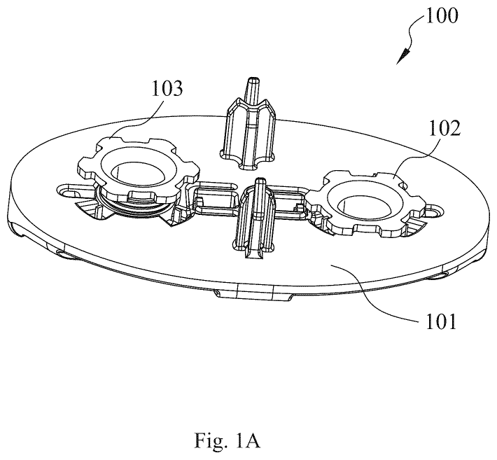

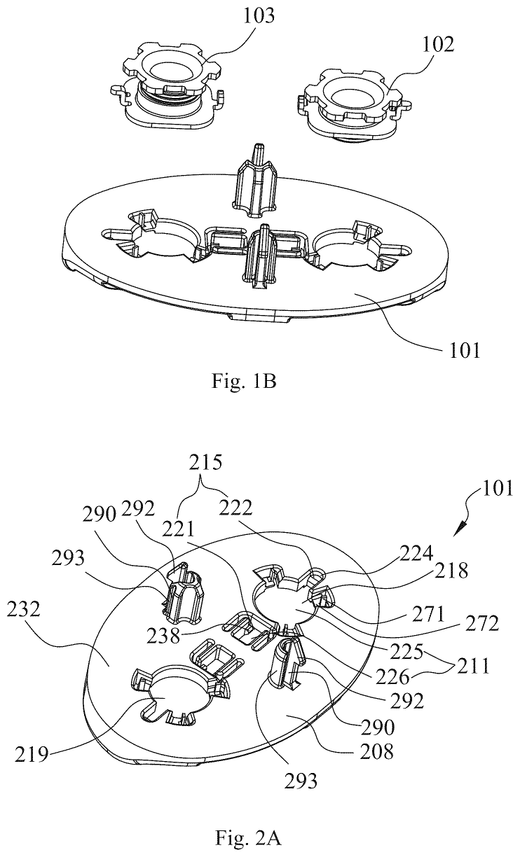

FIG. 1A is a perspective view of a tolerance compensation assembly according to the present disclosure, and FIG. 1B is an exploded view of the tolerance compensation assembly in FIG. 1A. As shown in FIGS. 1A and 1B, the tolerance compensation assembly 100 includes a holder 101 and a pair of nut assemblies 102 and 103, and the nut assemblies 102 and 103 are detachably mounted on the holder 101. The tolerance compensation assembly 100 is mounted between a first component and a second component to maintain a gap between the first component and the second component. The nut assemblies 102 and 103 are of the same structure. In another aspect of the present disclosure, one or more than two nut assemblies are provided.

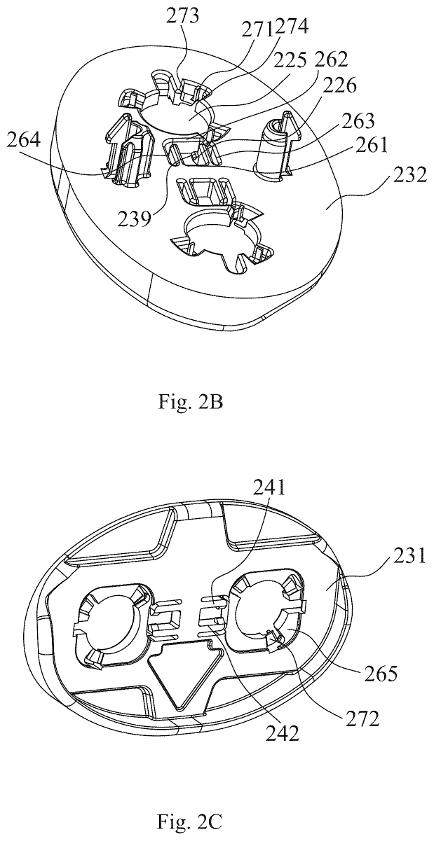

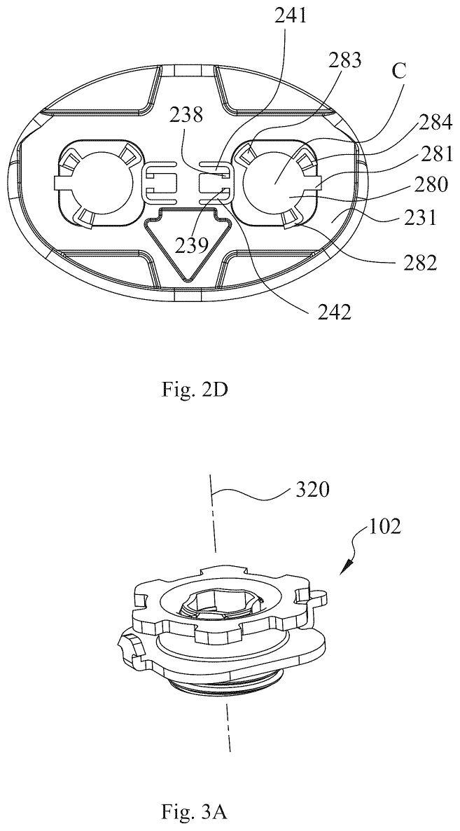

FIG. 2A is a perspective view of the holder in FIG. 1B, FIG. 2B is a perspective view of the holder in FIG. 2A from a second perspective, FIG. 2C is a perspective view of the holder in FIG. 2A from a third perspective, and FIG. 2D is a perspective view of the holder in FIG. 2A. FIGS. 2A to 2D show the shape and structure of the holder.

As shown in FIGS. 2A to 2D, the holder 101 includes a mounting portion 208 and a pair of fixing portions 290. The mounting portion 208 is substantially in an elliptic flat-plate shape, and has a first side 231 and a second side 232. FIGS. 2A and 2B show the second side 232 of the mounting portion 208, and FIGS. 2C and 2D show the first side 231 of the mounting portion 208. The mounting portion 208 has a pair of nut assembly connecting portions 218 and 219, and the nut assembly connecting portions 218 and 219 are connected to the nut assemblies 102 and 103, respectively. The pair of fixing portions 290 are disposed between the nut assembly connecting portions 218 and 219 and extend from the second side 232 of the holder 101. The pair of fixing portions 290 protrude from the second side 232 of the holder 101. Each fixing portion 290 has a vertical portion 293, the vertical portion 293 has a protrusion 292 at a distal end thereof, and the protrusion 292 can enter a corresponding hole of a mounting part so as to connect the holder 101 to the mounting part.

The nut assembly connecting portions 218 and 219 are of symmetrical structures, and the specific structures are described below by taking the nut assembly connecting portion 218 as an example. The nut assembly connecting portion 218 includes a mounting channel 211 and a holder connecting portion 215. The mounting channel 211 extends along a direction from the first side 231 to the second side 232 and runs through the first side 231 and the second side 232, and the nut assembly 102 can enter the mounting channel 211. The holder connecting portion 215 is connected to an inner wall 224 of the mounting channel 211. The holder connecting portion 215 is configured to fit with the nut assembly 102.

The mounting channel 211 includes a first portion 225 and a second portion 226, the first portion 225 and the second portion 226 are spaced apart from each other, and the first portion 225 is located at a side of the second portion 226. The first portion 225 includes a substantially circular central portion 280, and a first recess 281, a second recess 282, a third recess 283 and a fourth recess 284 disposed around the central portion 280. The first recess 281, the second recess 282, the third recess 283 and the fourth recess 284 are recessed from the central portion 280 and away from the center C of the central portion 280 along a radial direction. The first recess 281, the center C of the central portion 280, and the second portion 226 are on the same straight line. A platform portion 222 is provided in the first recess 281. The platform portion 222 is located in the first recess 281 and connected to the end of the first recess 281 away from the center C of the central portion 280. At the vicinity of the first recess 281, the platform portion 222 is lower than a surface of the second side 232 of the mounting portion 208, so as to form a step with the second side 232 of the mounting portion 208. The platform portion 222 is located inside the first portion 225, and the platform portion 222 does not exceed the surfaces of the first side 231 and the second side 232 in the extension direction of the mounting channel 211.

The second recess 282 includes a pair of side walls 273 and 274 arranged in a circumferential direction of the central portion 280. An clastic arm 272 is disposed in the second recess 282, the elastic arm 272 extends from the side wall 273 towards the side wall 274, and the clastic arm 272 has a distal end that is a free end and is spaced apart from the side wall 274. The clastic arm 272 is located inside the second recess 282 and is lower than the surface of the second side 232 of the mounting portion 208. The elastic arm 272 is provided with a limiting portion 271 at the distal end, and the limiting portion 271 extends from the distal end of the elastic arm 272 towards the second side 232 of the mounting portion 208 along the extension direction of the mounting channel 211, and exceeds the surface of the second side 232. That is to say, the extension direction of the limiting portion 271 is substantially perpendicular to the surface of the second side 232 of the mounting portion 208.

The third recess 283 and the fourth recess 284 have the same structure as the second recess 282, and similarly, the third recess 283 and the fourth recess 284 are each provided with the clastic arm 272 and the limiting portion 271, which will not be repeated herein. The second recess 282, the third recess 283 and the fourth recess 284 are distributed in the circumferential direction, and each recess is spaced apart from the adjacent recesses. The elastic arm 272 of each recess extends around the central portion 280.

The second portion 226 is substantially quadrilateral and has a pair of first inner side walls 261 and 262 disposed opposite each other and a pair of second inner side walls 263 and 264 disposed opposite each other. The first inner side wall 261 is located at the side of the second portion 226 away from the central portion 280, the first inner side wall 262 is located at the side of the second portion 226 close to the central portion 280, and the second inner side walls 263 and 264 are connected to two ends of the first inner side walls 261 and 262, respectively. A receiving portion 221 is provided in the second portion 226, and the receiving portion 221 includes a pair of holding arms 241 and 242. The holding arms 241 and 242 extend from the first inner side wall 261 towards the first inner side wall 262, and are spaced apart from the first inner side wall 262. The holding arms 241 and 242 are spaced apart from each other, and are spaced apart from the second inner side walls 263 and 264, respectively. Distal ends of the holding arms 241 and 242 can be bent away from each other. The distal ends of the holding arms 241 and 242 have holding arm bumps 238 and 239, respectively, and the holding arm bumps 238 and 239 extend towards each other. The holding arms 241 and 242 are both located inside the second portion 226, and do not exceed the surfaces of the first side 231 and the second side 232 of the mounting portion 208. That is to say, the receiving portion 221 is located in the mounting channel 211.

According to the present disclosure, the holder connecting portion 215 includes the platform portion 222 and the receiving portion 221, and the receiving portion 221 and the platform portion 222 are configured to connect the nut assembly 102.

The first side 231 of the holder 101 has a recess 265, the recess 265 is disposed around the mounting channel 211, and the recess 265 is recessed from the surface of the first side 231 towards the second side 232. The shape of the recess 265 fits with the shape of a mounting nut flange portion 401.

In another aspect of the present disclosure, the first portion 225 and the second portion 226 of the mounting channel 211 are interconnected structures without being separated.

In another aspect of the present disclosure, the platform portion 222 and the receiving portion 221 are not on the same line with the center of the central portion 280, and the platform portion 222 and the receiving portion 221 are disposed around the central portion 280 and are spaced apart from each other.

In still another aspect of the present disclosure, the number of the recesses 282, 283, 284 and of the corresponding elastic arms and limiting portions is not limited to three, and may be set to any number as required.

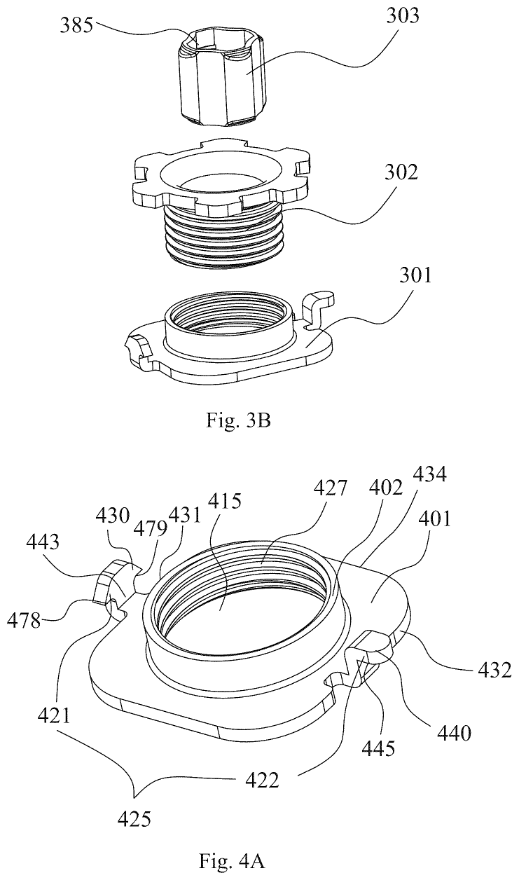

FIG. 3A is a perspective view of the nut assembly in FIG. 1B, and FIG. 3B is an exploded view of the nut assembly in FIG. 1B. In FIG. 1B, the nut assemblies 102 and 103 are of the same structure, and FIGS. 3A and 3B illustrate the structure of the nut assembly by taking the nut assembly 102 as an example. As shown in FIGS. 3A and 3B, the nut assembly 102 includes a mounting nut 301, an adjusting nut 302, and a sleeve 303. The adjusting nut 302 is disposed in the mounting nut 301 and is rotatable relative to the mounting nut 301 so as to adjust the length of the nut assembly 102. The sleeve 303 is disposed in the adjusting nut 302 and is rotatable with the adjusting nut 302. The sleeve 303 is barrel-shaped and has a sleeve channel 385. The sleeve 303 is configured to increase the friction between the adjusting nut 302 and a fastening assembly such as a screw. The nut assembly 102 extends along the axial direction and has a central axis 320.

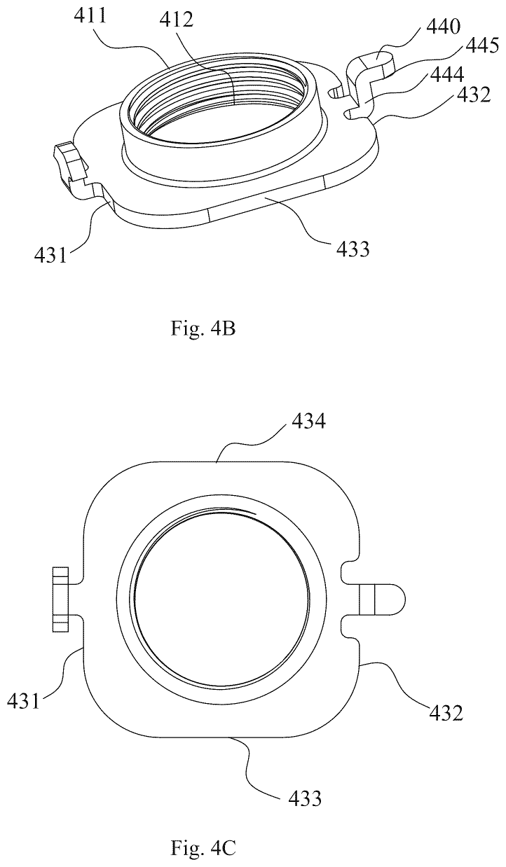

FIG. 4A is a perspective view of the mounting nut in FIG. 3B, FIG. 4B is a perspective view of the mounting nut in FIG. 4A from another perspective, and FIG. 4C is a bottom view of the mounting nut in FIG. 4A. FIGS. 4A to 4C show a structure of the mounting nut.

As shown in FIGS. 4A to 4C, the mounting nut 301 includes the mounting nut flange portion 401, a mounting nut barrel portion 402, and a nut connecting portion 425. The mounting nut barrel portion 402 extends along the direction of the central axis 320 of the nut assembly 102 and has a first end 411 and a second end 412. The mounting nut barrel portion 402 is substantially in the shape of a hollow cylinder so as to enclose a nut receiving channel 415. The nut receiving channel 415 can receive the adjusting nut 302. An inner wall of the mounting nut barrel portion 402 has an internal thread 427 that can fit with an external thread of the adjusting nut 302. The mounting nut flange portion 401 extends outwards from the second end 412 of the mounting nut barrel portion 402 along the radial direction of the nut assembly. The mounting nut flange portion 401 has an outer contour substantially in the shape of a quadrilateral having arc chamfers, such that the mounting nut flange portion 401 is in an anti-rotation shape. The shape of the mounting nut flange portion 401 fits with the shape of the recess 265 of the holder 101, such that the mounting nut flange portion 401 can enter the recess 265 to limit the rotation of the mounting nut 301 relative to the holder 101.

The mounting nut flange portion 401 has a first side 431 and a second side 432 disposed opposite each other and a third side 433 and a fourth side 434 disposed opposite each other. The nut connecting portion 425 is connected to the first side 431 and the second side 432.

The nut connecting portion 425 includes a leg 421 and a hook portion 422. The leg 421 is connected to the first side 431 and extends towards the first end 411 of the mounting nut barrel portion 402 along the axial direction of the mounting nut barrel portion 402. The leg 421 includes a rod portion 443 and a protrusion 430, the rod portion 443 is connected to the first side 431, and the protrusion 430 is connected to the rod portion 443 and located at a distal end of the leg 421. The protrusion 430 extends from two sides of the rod portion 443 towards the third side 433 and the fourth side 434, so as to form a pair of steps 478 and 479 with the two sides of the rod portion 443. The steps 478 and 479 can cooperate with the holding arm bumps 238 and 239 of the receiving portion 221 to hold the protrusion 430 between the holding arms 241 and 242.

The hook portion 422 is connected to the second side 432 and extends towards the first end 411 of the mounting nut barrel portion 402 along the axial direction of the mounting nut barrel portion 402. The hook portion 422 includes a rod portion 444 and a claw portion 440, the rod portion 444 is connected to the second side 432, and the claw portion 440 is connected to the rod portion 444 and located at a distal end of the hook portion 422. The claw portion 440 extends from an end of the rod portion 444 and away from the central axis of the nut assembly along the radial direction of the nut assembly 102, such that a step 445 is formed between the claw portion 440 and the rod portion 444. The step 445 can cooperate with the platform portion 222.

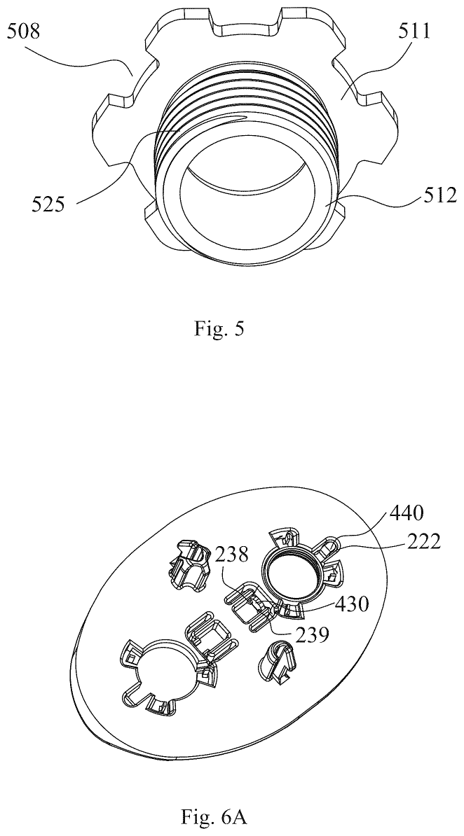

FIG. 5 is a perspective view of an adjusting nut in FIG. 3B. As shown in FIG. 5, the adjusting nut includes an adjusting nut flange portion 511 and an adjusting nut barrel portion 512. The adjusting nut flange portion 511 extends from one end of the adjusting nut barrel portion 512 and away from the central axis of the nut assembly 102 along the radial direction of the nut assembly 102. An outer surface of the adjusting nut barrel portion 512 is provided with an external thread 525 that can fit with the internal thread 427 of the mounting nut barrel portion 402 such that the adjusting nut 302 can rotate relative to the mounting nut 301 to change the length of the nut assembly 102. The adjusting nut flange portion 511 has a plurality of notches 508, and the plurality of notches 508 are recessed inwards (i.e., towards the central axis of the nut assembly) from an edge of the adjusting nut flange portion 511. Thus, the adjusting nut flange portion 511 has an outer contour shaped like a gear. The plurality of notches 508 are configured to cooperate with the limiting portion 271. When the adjusting nut 302 and the mounting nut 301 are closest to each other, the limiting portion 271 can enter at least one notch 508 of the plurality of notches 508 to limit the rotation of the adjusting nut 302 relative to the mounting nut 301.

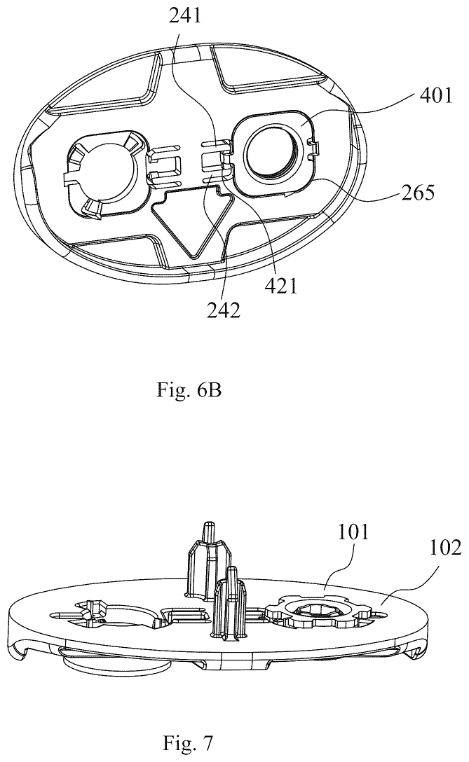

FIG. 6A is a perspective view of the mounting nut in FIG. 3B and the holder in FIG. 1B, and FIG. 6B is a perspective view of the mounting nut in FIG. 3B and the holder in FIG. 1B from another perspective. In order to facilitate showing the connection relationship between the mounting nut and the holder, the adjusting nut and the sleeve are not shown in FIGS. 6A and 6B. When the mounting nut 301 is connected to the holder 101, the mounting nut 301 is mounted into the mounting channel 211 from the first side 231 of the mounting portion 208 of the holder 101. During mounting, the claw portion 440 of the hook portion 422 of the mounting nut 301 abuts against the platform portion 222 of the holder 101, then the mounting nut barrel portion 402 is aligned with the first portion 225 of the mounting channel 211 and the leg 421 of the mounting nut 301 is aligned with the second portion 226 of the mounting channel 211. The leg 421 of the mounting nut 301 is pressed such that the protrusion 430 of the leg 421 of the mounting nut 301 enters a gap between the holding arms 241 and 242, the protrusion 430 compresses the holding arm bumps 238 and 239 such that the distal ends of the holding arms 241 and 242 are bent away from each other until the protrusion 430 passes through the spacing between the holding arm bumps 238 and 239, and then the distal ends of the holding arms 241 and 242 are restored from the deformation and the steps of the protrusion 430 abut against the holding arm bumps 238 and 239, thereby holding the mounting nut 301 in the mounting channel 211.

In FIGS. 6A and 6B, the mounting nut and the holder are connected in place. As shown in FIGS. 6A and 6B, the mounting nut barrel portion 402 enters the first portion 225 of the mounting channel 211, and the size of the mounting nut barrel portion 402 matches the size of the central portion 280 of the first portion 225 to limit the movement of the mounting nut 301 relative to the holder 101 along the radial direction of the nut assembly. The claw portion 440 of the hook portion 422 of the mounting nut 301 abuts against the platform portion 222 of the holder 101 to limit the movement of the claw portion 440 relative to the holder 101 along the axial direction of the nut assembly. The protrusion 430 of the leg 421 abuts against the holding arm bumps 238 and 239 to limit the movement of the protrusion 430 relative to the holder 101 along the axial direction of the nut assembly. The mounting nut flange portion 401 enters the recess 265 of the holder 101. The mounting nut flange portion 401 and the recess 265 of the holder 101 are both in a non-circular anti-rotation shape, such that the mounting nut 301 cannot rotate relative to the holder. In this aspect, the mounting nut 301 is detachable from the holder 101.

In the present disclosure, the structures connecting the mounting nut 301 to the holder 101 are disposed within the mounting channel 211, thereby saving space in the axial direction of the nut assembly.

In an aspect of the present disclosure, the mounting nut 301 includes a pair of legs, the holder includes a pair of receiving portions, and the pair of legs cooperate with the pair of receiving portions to connect the mounting nut 301 to the holder 101, omitting the hook portion and the platform portion.

FIG. 7 is a perspective view of one nut assembly and the holder in FIG. 1B. As shown in FIG. 7, the nut assembly 102 is mounted on the holder 101. The mounting nut 301 and the adjusting nut 302 are closest to each other, that is, the nut assembly 102 has the minimum length. In this case, at least one limiting portion 271 of the holder 101 enters at least one notch 508 of the adjusting nut 302. The cooperation between the limiting portion 271 and the notch 508 can limit the rotation of the mounting nut 301 relative to the adjusting nut 302 towards a direction of causing loosening, so as to prevent loosening or disengagement of the mounting nut 301 from the adjusting nut 302 due to vibration or other reasons during transportation.

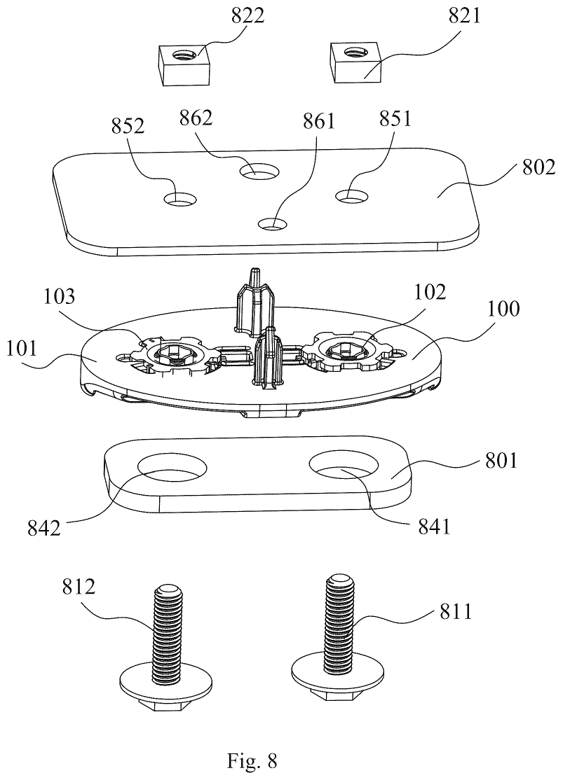

FIG. 8 is a perspective view of the tolerance compensation assembly in FIG. 1A, a first component, a second component, and fastening bolts. As shown in FIG. 8, the tolerance compensation assembly 100 includes the holder 101, and the pair of nut assemblies 102 and 103 mounted on the holder 101. The fastening bolts include screws 811 and 812 and nuts 821 and 822. The tolerance compensation assembly 100 cooperates with the fastening bolts to connect the first component 801 and the second component 802 and also provide support between the first component 801 and the second component 802 so as to prevent the first component 801 and the second component 802 from being collapsed.

The first component 801 includes a pair of bolt mounting holes 841 and 842. The second component 802 includes a pair of screw mounting holes 851 and 852 and a pair of holder mounting holes 861 and 862.

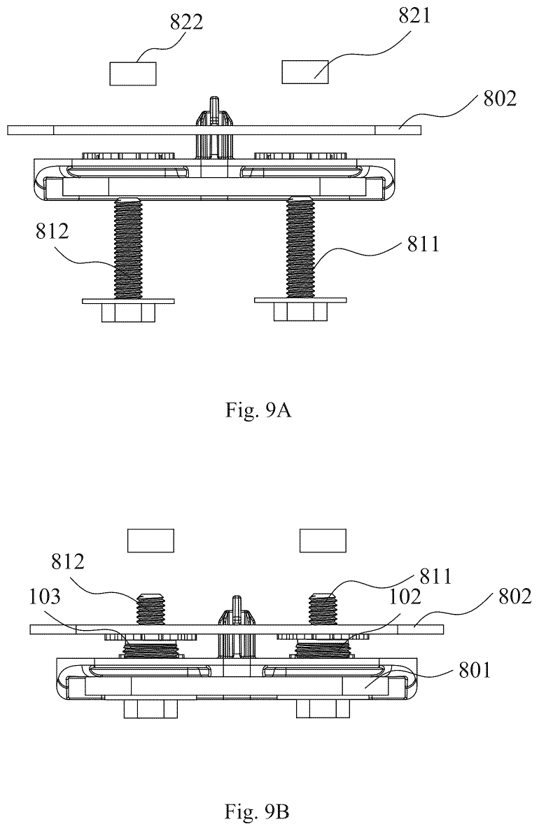

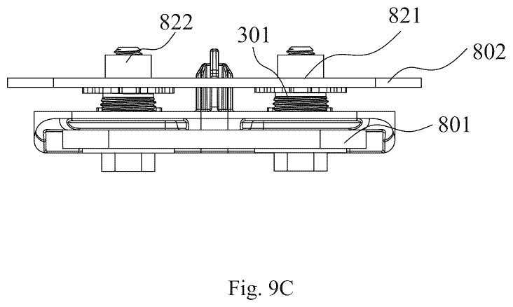

FIG. 9A is a side view of the tolerance compensation assembly connected with the second component, FIG. 9B is a side view of the tolerance compensation assembly adjusted to an appropriate length, and FIG. 9C is a schematic view of the first component and the second component connected to each other in a fastening manner.

As shown in FIG. 9A, when the first component 801 is connected to the second component 802, the pair of fixing portions 290 of the tolerance compensation assembly 100 are aligned with the holder mounting holes 861 and 862 of the second component to facilitate mounting of the holder 101 into the second component 802.

When the pair of fixing portions 290 of the tolerance compensation assembly 100 enter the holder mounting holes 861 and 862 of the second component, the sleeve channels 385 of the nut assemblies 102 and 103 of the tolerance compensation assembly 100 are aligned with the screw mounting holes 851 and 852 of the second component 802, respectively.

As shown in FIG. 9B, the screws 811 and 812 pass through the bolt mounting holes 841 and 842 of the first component 801, and the screws 811 and 812 are inserted into the respective sleeve channels 385 of the nut assemblies 102 and 103. Due to the large friction between the screws 811 and 812 and the sleeves 303, the rotation of the screws 811 and 812 can drive the adjusting nuts 302 to rotate by means of the sleeves 303. The adjusting nuts 302 rotate as the screws 811 and 812 rotate, and thus move towards the second component 802 until the adjusting nuts abut against the lower surface of the second component 802.

As shown in FIG. 9C, an operator continues to rotate the screws 811 and 812, and the adjusting nuts 302 are blocked by the second component 802 and thus cannot be further rotated. The operator then applies force to the screws 811 and 812 to overcome the friction force between the sleeves 303 and the screws 811 and 812, such that the screws 811 and 812 pass through the screws mounting holes 851 and 852 of the second component 802. The operator then places the nuts 821 and 822 onto the screws 811 and 812, and rotates the nuts 821 and 822 to appropriate positions, so as to connect the first component 801 and the second component 802.

The nut assemblies 102 and 103 are provided between the first component 801 and the second component 802 and thus provide support for the first component 801 and the second component 802, so as to prevent the first component 801 or the second component 802 from being deformed when the nuts 821 and 822 are rotated.

In one application of the present disclosure, the first component is a body sheet metal of a vehicle, and the second component is a rear spoiler of the vehicle.

In the present disclosure, the nut assembly is detachable from the holder of the tolerance compensation assembly to facilitate manufacturing. The structures connecting the nut assembly to the holder are disposed inside the mounting channel, such that the tolerance compensation assembly has a small size in the axial direction of the nut assembly and is suitable for use in a narrow mounting space. According to the present disclosure, the holder further has the limiting portion, which can prevent the nut assembly from loosening during transportation.

Although the present disclosure is described in conjunction with the examples of aspects outlined above, various alternatives, modifications, variations, improvements and/or substantial equivalents, which are known or anticipated at present or to be anticipated before long, may be obvious to those of at least ordinary skill in the art. In addition, the technical effects and/or technical problems described in this specification are exemplary rather than limiting; therefore, the disclosure in this specification may be used to solve other technical problems and may have other technical effects. Accordingly, the examples of the aspects of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements and/or substantial equivalents.

What is claimed is:

1. A tolerance compensation assembly, comprising:
a nut assembly comprising:
a mounting nut comprising a mounting nut barrel portion and a nut connecting portion connected to the mounting nut barrel portion, the mounting nut barrel portion having an internal thread; and
an adjusting nut having an external thread, the adjusting nut being configured to be at least partially received in the mounting nut barrel portion, and the adjusting nut being rotatable relative to the mounting nut by means of thread fit so as to move relative to the mounting nut along an axial direction of the nut assembly; and
a holder having a mounting channel and a holder connecting portion, the holder connecting portion being configured to fit with the nut connecting portion such that the mounting nut is capable of being held in the mounting channel, and the holder connecting portion and the nut connecting portion being at least partially disposed within the mounting channel.

2. The tolerance compensation assembly of claim 1, wherein
the holder comprises a flat plate-shaped mounting portion, the mounting portion having a first side and a second side disposed opposite each other, the mounting channel running through the first side and the second side, and the holder connecting portion and the nut connecting portion being disposed within the mounting channel (211).

3. The tolerance compensation assembly of claim 1, wherein
the mounting nut further comprises a mounting nut flange portion extending outwards from one end of the mounting nut barrel portion along a radial direction of the nut assembly, the nut connecting portion being connected to the mounting nut flange portion and extending towards the other end of the mounting nut barrel portion along the axial direction of the nut assembly.

4. The tolerance compensation assembly of claim 2, wherein
the nut connecting portion comprises at least one leg having a proximal end connected to one side of the mounting nut; and
the holder connecting portion comprises at least one receiving portion having a proximal end connected to an inside wall of the mounting channel, the at least one receiving portion being elastic, and a distal end of the at least one leg being connected to a distal end of the at least one receiving portion by means of a snap-fit structure.

5. The tolerance compensation assembly of claim 4, wherein
the distal end of the at least one leg has a protrusion, the at least one receiving portion comprises a pair of holding arms, and distal ends of the pair of holding arms are movable away from each other such that the protrusion of the at least one leg is capable of being inserted between the pair of holding arms.

6. The tolerance compensation assembly of claim 4, wherein
the nut connecting portion further comprises at least one hook portion, a distal end of the hook portion having a claw portion extending along a radial direction of the nut assembly; and
the holder connecting portion comprises at least one platform portion, the claw portion being capable of cooperating with the platform portion to limit movement of the claw portion relative to the platform portion along the axial direction of the nut assembly;
wherein the at least one hook portion is spaced apart from the at least one leg.

7. The tolerance compensation assembly of claim 3, wherein
the mounting nut flange portion is in an anti-rotation shape, the first side of the holder has a recess, the shape of the recess fitting with the shape of the mounting nut flange portion, and the mounting nut flange portion being capable of entering the recess to limit the rotation of the mounting nut relative to the holder.

8. The tolerance compensation assembly of claim 3, wherein
the adjusting nut comprises an adjusting nut flange portion and an adjusting nut barrel portion, the adjusting nut flange portion extending outwards from one end of the adjusting nut barrel portion along the radial direction of the nut assembly, the external thread being disposed on an outer surface of the adjusting nut barrel portion, the adjusting nut barrel portion being capable of entering the mounting nut barrel portion, and the adjusting nut flange portion having at least one notch; and
the holder has at least one limiting portion, the limiting portion (271) being configured to be capable of entering the at least one notch to limit the rotation of the adjusting nut relative to the mounting nut.

9. The tolerance compensation assembly of claim 8, wherein
the holder comprises at least one elastic arm, the elastic arm having a proximal end connected to an inner side of the mounting channel and having a distal end that is a free end, and the at least one limiting portion being connected to the distal end of the elastic arm and extending along the axial direction of the nut assembly; and
wherein the elastic arm extends around the mounting nut barrel portion.

10. The tolerance compensation assembly of claim 8, wherein
the at least one notch comprises a plurality of notches uniformly distributed in a circumferential direction, and the at least one limiting portion comprises a plurality of limiting portions, at least one of the plurality of limiting portions being capable of entering the corresponding one notch of the plurality of notches.

11. The tolerance compensation assembly of claim 1, wherein
the holder comprises at least two mounting channels and a fixing portion, the at least two mounting channels allowing mounting of at least two nut assemblies, and the fixing portion being connectable to a mounting part.

12. The tolerance compensation assembly of claim 8, wherein
the nut assembly further comprises a hollow sleeve disposed in the adjusting nut barrel portion.
